(19) United States
(12) Patent Application Publication
(10) Pub. No.: US 2009/0240776 A1
(43) Pub. Date: Sep. 24, 2009

(54) XML2 X-MAIL (TM) 2

(76) Inventor: GABE CHERIAN, SUN VALLEY, ID (US)

Correspondence Address: GABE CHERIAN, P.O. BOX 1335, SUN VALLEY, ID, 83353, US

(21) Appl. No.: 12/368,865

(22) Filed: Feb. 10, 2009

Related U.S. Application Data
(63) Continuation-in-part of application No. 11/740,868, filed on Apr. 26, 2007.
(60) Provisional application No. 61/027,805, filed on Feb. 11, 2008.

(51) Int. Cl. G06F 15/82

(52) U.S. Cl. 709/206

(57) ABSTRACT

The Mother invention, XML1, covers certain improvements to the Internet methods of handling “stray” email messages, which are sent to old “invalid” email addresses. It provides means and methods to salvage such stray messages. It proposes to establish a depository data center, which could be referred to as the XMAIL™ Center, with appropriate infrastructure, to store information in database files, correlating old “invalid” email addresses of participating users to their corresponding new “valid” email addresses. On demand and according to the wishes of the participants, the XMAIL™ Center can provide the necessary information to help in forwarding/delivering such stray messages to their intended recipients. The present invention combines the above XMAIL™ approach with the prior art spam filters and sniffing filters, in order to improve the effectiveness of the system and to create certain additional efficiencies in the total email traffic system.

### CROSS-REFERENCE TO RELATED APPLICATIONS

This application is a NON-PROVISIONAL UTILITY patent application, and it is claiming the priority and benefits of PROVISIONAL PATENT APPLICATION Ser. No. 61/027,805, filed Feb. 11, 2008, entitled “XML2”, which is incorporated herein in its entirety by reference. I will refer to this Provisional patent application as the “PPA” or “Ref1”.

This patent application is also a Continuation In Part (CIP) to the Non-Provisional patent application Ser. No. 11/740,868 Filed Apr. 26, 2007 Title: X-MAIL™ (Mother Application), which is still pending. I will refer to this Mother Application as “XML1” or as “Ref2”. This CIP incorporates all the priorities and privileges of the Mother Application in its entirety. This PPA continues what has been covered in my Mother Application XML1.

### STATEMENT REGARDING FEDERALLY SPONSORED RESEARCH OR DEVELOPMENT

Not Applicable

### REFERENCE TO A MICROFICHE APPENDIX

Not Applicable

### Note

I will first copy here below a lot of EXCERPTS from the specification of the Mother Application, XML1 or Ref1, and then I will introduce after that the new additions covered by this present application. The reason for this is that I want to use many of the text used in XML1 in the claims of the present application.

### Excerpts from My XML1 Specification

### The Invention

The purpose of this new invention here is to overcome the difficulties mentioned above.

In brief, the invention's main objective is to create an automatic method of redirecting the so-called “undeliverable” or “stray” email messages to the new address. A second objective is to alert the recipient user that a “redirection” has occurred. A third objective is to notify the sender(s) about the new address for future use, either automatically or optionally, if the recipient wishes that this be done.

The method of accomplishing these objectives is described here below.

### PRIOR ART

### 1—Patent Search

I could not find any Prior Art Patents that teach what I am proposing here in the present patent application here. I found the two following patents, which teach something close, but not close enough to make them obstacles against my proposed inventions.
1. U.S. Pat. No. 6,064,981 to Barni et al., Method for online display and negotiation of cargo rates.
2. U.S. Pat. No. 3 6,070,147 to Harms et al., Customer identification and marketing analysis systems.

### PRIOR ART

### 2—A New System on the Market

Just a few days ago, I heard about a new website called “Grand Central”, “http://www.grandcentral.com/”. It offers something similar to what I am proposing here, but it works with telephone numbers only. It does not address the issues with Emails on the Internet. I do not know what patent coverage they have. But, it proves that there is a need for a system like the one I am proposing here.

### PRIOR ART

### 3—How the Present System Works

I will first describe how the present system works, based on what I have learned from reading the Reference Books listed above and from a few other sources. Then further down below, I will describe my proposed solutions.

Existing/Present Method of Delivering Email Messages:

The Internet is a fairly complex system. Its protocols and functions are based on various rules, methods and systems, which make the whole Internet function as smoothly as it does. I will highlight just a few of those methods to explain the essential features, which will ultimately lead to my proposed changes and improvements.

DOMAINS AND SUBDOMAINS. An extremely large volume of email messages and Internet traffic is handled on the Internet by what is called host computers, which are referred to also as clients and servers. These computers are grouped, organized and named in a specific fashion as shown in FIGS. 1-4. There are several methods of organizing and naming these host computers. It seems that the ones that are used most are: 1) DNS database method, 2) UNIX filesystem method, and 3) The ARPA Domain method, as in FIGS. 1-4.

NAMING METHODS. The naming format in each of these methods is slightly different, but basically they all have the same approach and end goal. They use a hierarchical approach, with several levels or tiers, called domain and subdomains, and the naming is done so as to make it easy to locate any specific host computer. It looks like a genealogical tree.

An example could be the name “winnie.corp.hp.com” for a specific computer, as shown in FIG. 3 and in the left side of FIG. 4. This is a “hierarchical” way of calling names. It is similar to a genealogical tree. I would call this method a “bottom up” or ascending method. Here, “winnie” is a computer node under the node “corp”, which is under the node “hp”, which is under the node “com”, which is under the “root” node. This is the DNS database method

The right side of FIG. 4 shows an example of the UNIX filesystem method. I would call it the “top down” or descending method.

A similar method is used for naming individual users. For example, a name for a specific user, say for Mr. Albert Einstein, who is connected with UC Berkeley, could be “aeinstein@berkeley.edu”, where “aeinstein’ is the name of the user, who is “reachable” at the node “berkeley”, which is under the node “edu”, which is understood to be under the “root” node.

SENDMAIL. The traffic of email messages on the Internet is handled by specific programs. See FIG. 5. The following names can be seen: SMTP, Mail1, uux rmail, uuxqt rmail, Mail, MH(XMH), Elm. But the focal point is the program called Sendmail.

SENDMAIL is used to facilitate and to control the procedures and rules of transferring email messages between senders and recipients. A lot of the procedures and “rules” are described in documents called “RFC”, which stands for “Request For Comments”. Some of the most important RFCs, which relate to email transfer, are RFC821, RFC822, RFC819, RFC976, RFC1123, RFC1521, RFC1522, RFC1651, RFC1652, RFC1653, RFC1891, RFC1892, RFC1893, and RFC1894. See Reference Book #1 and #2. I am sure that more RFCs are still being generated.

THE RESOLUTION PROCESS. The way an email message is transferred from one computer (Sender) to another computer (Recipient) is illustrated in FIG. 6. Please see also the list of the steps that occur in FIG. 6. These steps are shown in page 16 of the present application.

The figure shows an example of how to find the location of the host computer of the Recipient User named “girigiri.gbrmpa.gov.au”.

The Sender computer needs to know which Recipient Computer is hosting this Recipient User. So, the Sender computer uses a “Resolver” to do that. In FIG. 6, we can see that the Sender computer is called the Client and is acting as the Resolver.

The Resolver sends a query 1Q to a Local name server.

The local name server sends a query 2Q to the Root name server. The Root name server sends an answer 3R to query 2Q to the Local name server, referring it to the “au” name server. So now, the local name server has located the first level name server, which handles the “au” part of the Recipient User name.

Then, the local name server repeats the process to locate the next level server down. It sends another query 4Q to the “au” name server. The “au” name server sends an answer 5R to query 4Q to the Local name server, referring it to the “gov” name server. So, now the local name server has located the second level name server, which handles the “gov.au” part of the Recipient User name.

Again, the local name server repeats the process to locate the next level server down. It sends another query 6Q to the “gov.au” name server. The “gov.au” name server sends an answer 7R to query 6Q to the Local name server, referring it to the “gbrmpa.gov.au” name server. So, now the local name server has located the third level name server, which handles the “gbrmpa.gov.au” part of the Recipient User name.

One last time, the local name server repeats the process to locate the next level server down. It sends another query 8Q to the “gbrmpa.gov.au” name server. The “gbrmpa.gov.au” name server sends an answer 9A to query 8Q to the Local name server, giving it the full address of the recipient, which is “girigiri.gbrmpa.gov.au”.

Now the Local Name Server has the full address and knows where the recipient is, it sends an answer 10A to the Client Resolver informing it of the exact location and address of the recipient. Now it is up to the Client to send the message to his recipient.

FIG. 7 shows the resolution process in a different way. Please see also the list of the steps that occur in FIG. 7. These steps are shown in page 16 of the present application.

It shows A as the Local Name Server of FIG. 6, and B, C, and D as some of the other Name Servers of FIG. 6. Basically, it is an iterative process, going down the hierarchy line, resolving for the segments of the email address one step after the other, as explained above for FIG. 7.

FIG. 8 shows another example, where the system is resolving for “baobab.cs.berkeley.edu”. Please see also the list of the steps that occur in FIG. 8. These steps are shown in page 17 of the present application.

I guess now, it is clear how the system works.

SUMMARY. So, in summary, the search to establish the connection follows the hierarchical names, going from the top node and proceeding to the lower nodes, one step at a time, as illustrated very nicely in these 3 figures, FIGS. 6 through 8.

NECESSARY NAMES COMPONENTS. For this reason, when a message is sent to a certain recipient, the message should have the address of the recipient. Recipients' names have the format that facilitates in locating the specific recipient. First, you need to give the user's own name and then you need to give a name of the host computer/server, which hosts this specific.

### The Problem

The problem occurs, when an email message is sent to an address that is not valid anymore, the system does not know where to send the message. The system attempts to re-send the message a few times. If the attempts fail, then the message is forwarded to a place, which sends a “Mailer-Daemon” message to the sender, informing the sender that the message is “undeliverable”, because the address is “invalid”.

Ultimately the message is discarded by the system.

It is then up to the sender to search and attempt to find a “valid” address of the recipient and then send his message to the newly found address, or he/she despairs and abandons all attempts.

### SUMMARY OF THE INVENTION

### My Proposed Solution

I would establish a sort of an “email exchange station” or an “email address exchange station”, or better yet a “universal email station” and/or an independent “email ISP”.

I would create database files, which would contain old “invalid” addresses of users together with their corresponding “valid” addresses. I would place/store these database files in a repository storage, like a “server” computer. I would give this computer an appropriate name, such as “XMAIL™”. Other possible names could be “EMAIL-EXCHANGE™”, “NAME-EXCHANGE™”, “THE-HUB™”, “EMAIL HUB™, “EMAIL CENTRAL™”, or the like.

Whenever necessary, the SENDMAIL program and any other related Internet program or the like, would be modified and/or re-configured, so that it would “divert” or “redirect” or “forward” all “undeliverable” and/or “stray” messages to my “XMAIL™” server. XMAIL™ would in turn give out, as the required “answer”, the correct “valid” address that corresponds to the so-called “invalid” address in each specific message, so that the message could be delivered to the appropriate receiver.

Of course, there could be cases where XMAIL™ will not have the appropriate information in its database files, in which case the system would digress to the old method of Mailer-Daemon notification to the sender.

The system will also provide several options to the “subscribers” including at least the following:

1. Establish a permanent email address,

2. Use XML1 as their direct ISP and their permanent “email home”,

3. Whether to notify or not to notify the Sender of the new address of the Recipient,

4. Whether the Recipient would be notified or not notified about the fact that the Sender did not know the new address,

5. Recipient will instruct XML not to forward the message, but to be notified about it and then Recipient to decide whether to obtain it or to delete it,

etc.

### BRIEF DESCRIPTION OF THE DRAWINGS

FIGS. 1-8 show the Prior Art, i.e. the present way the email messages are handled on the Internet, and the reasoning behind the formats of users' names and servers' names.

FIG. 9 shows the situation when the XML node is introduced in the Internet system, and the two additional query/answer steps that will be added to the Resolution procedure. Please see also the list of the steps that occur in FIG. 9. These steps are shown in page 17 of the present application.

FIG. 10 shows how XML node could fit into the Internet scheme of node. In this case, the XML node is immediately under the root node.

FIG. 11 shows a different way of how XML node could fit into the Internet scheme of node. In this case, the XML node is as a lower level node. In this case it is under a top level node, such as a “.com” node.

FIG. 12 shows schematic flow chart of how the introduction of XML into the Internet system would affect the information about old and new email addresses and the flow of email messages.

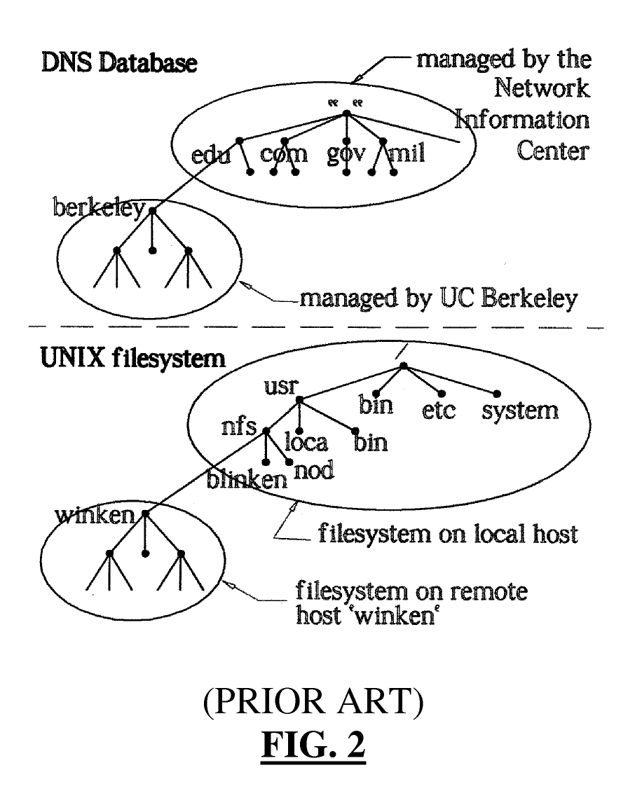

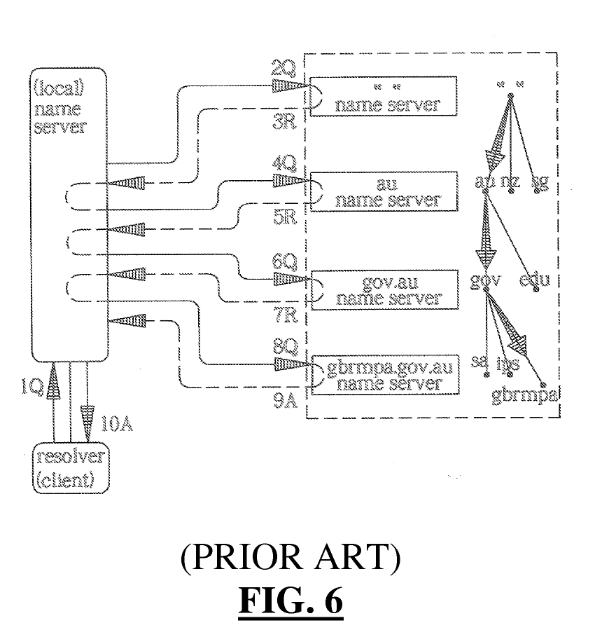

### NOTES & CORRECTIONS OF FIGS. 2-4 & FIGS. 6-9

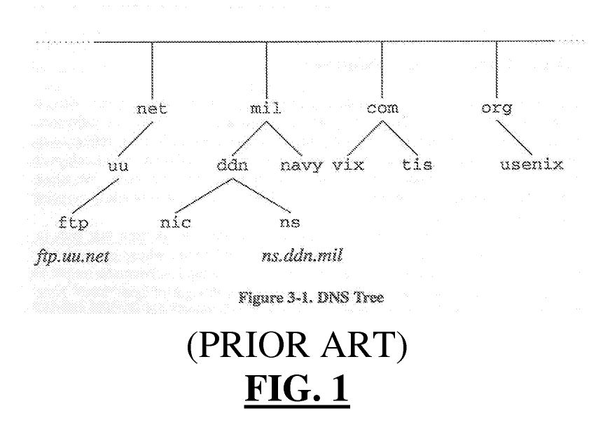

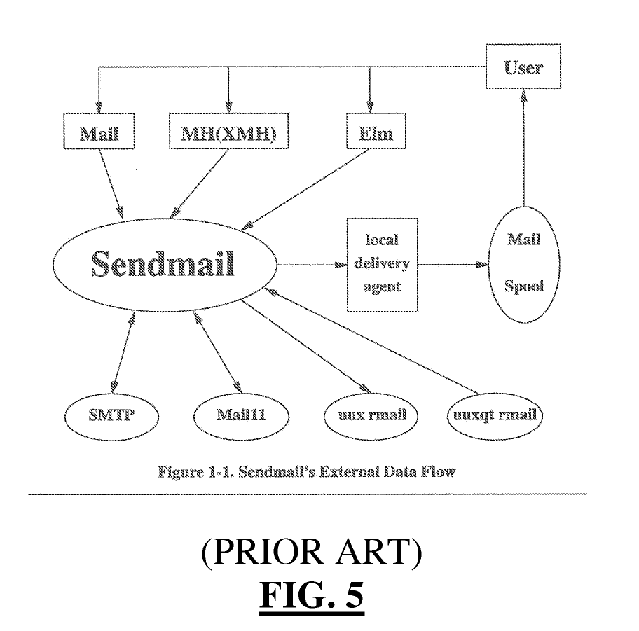

FIGS. 1 through 9 are reproductions of figures in the Reference Book, Ref#3, listed in page 2 of the mother application, patent application Ser. No. 11/740,868; Filed Apr. 26, 2007; Title—X-MAIL™. The Title of the “Ref3” book is “DNS and BIND, 3^{rd} Edition”, and it is written by Paul Albitz & Cricket Liu, Printed September 1998, ©1998, 1997, 1992 O'Reilly & Associates, O'Reilly ISBN 1-56592-512-2.”

Originally, I had copied these figures, FIGS. 1 through 9 of the present application, directly from the book, but they turned out to be unacceptable. Some of the text in the figures was too small and some of the drawings were shaded in an unacceptable way. I also had included the “captions” of the book figures in the patent application figures and that was confusing.

So, I made the following several changes to the application figures.

First, I elminated the book captions.

Second, I retraced all the figures using line drawing, and eliminated any unacceptable “shadings”.

Finally, I replaced all the text by new, larger font text.

However, because of the amount of the text and the amount of contents of the figures, there was not enough room to fit the entire text wording in the new figures. So, I have “abbreviated” most of the text and used shorter “names” whenever necessary, and as listed below.

I have listed here below, the respective “original captions” of the corrected drawings:

FIG. 2 original book caption was “FIG. 1-3 Remote management of subdomains and of filesystems”.

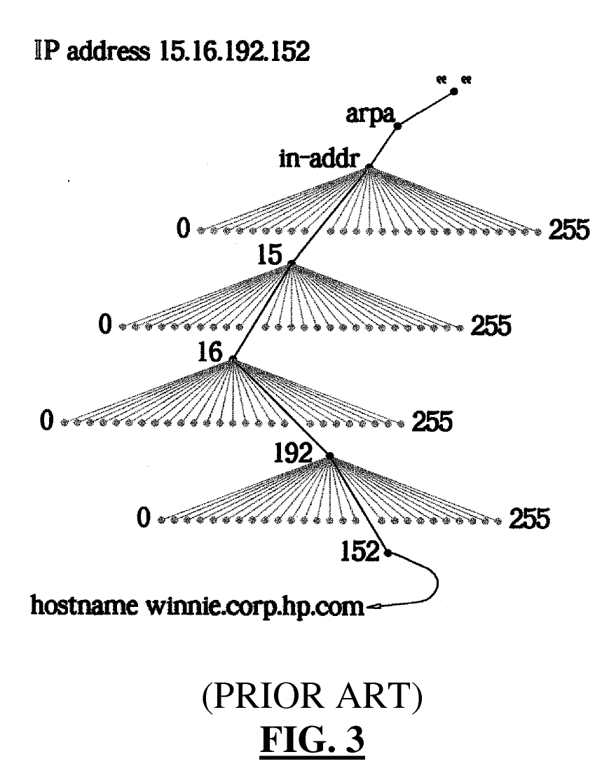

FIG. 3 original book caption was “FIG. 2-14. addr.arpa domain”.

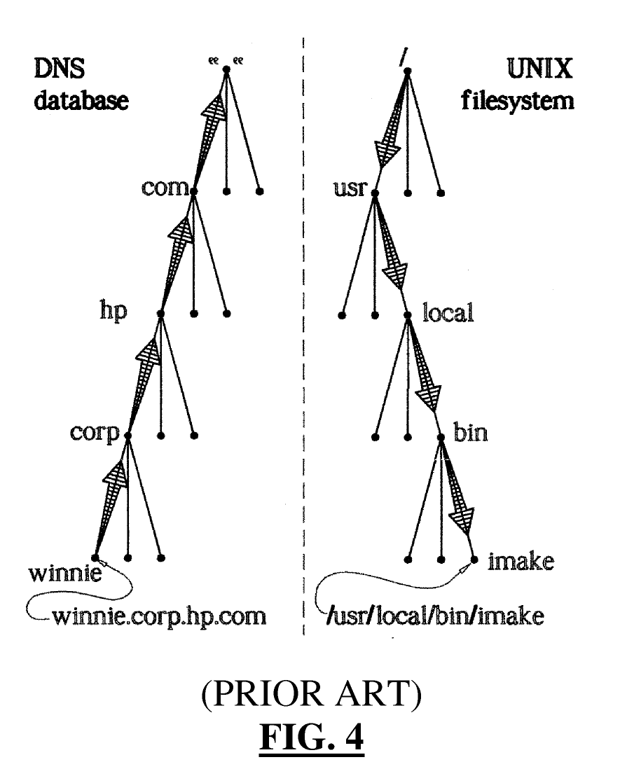

FIG. 4 original book caption was “FIG. 1-2. Reading names in DNS and in a UNIX filesystem”.

FIG. 6 original book caption was “FIG. 2-12. Resolution of girigiri.gbrmpa.gov.au on the Internet”.

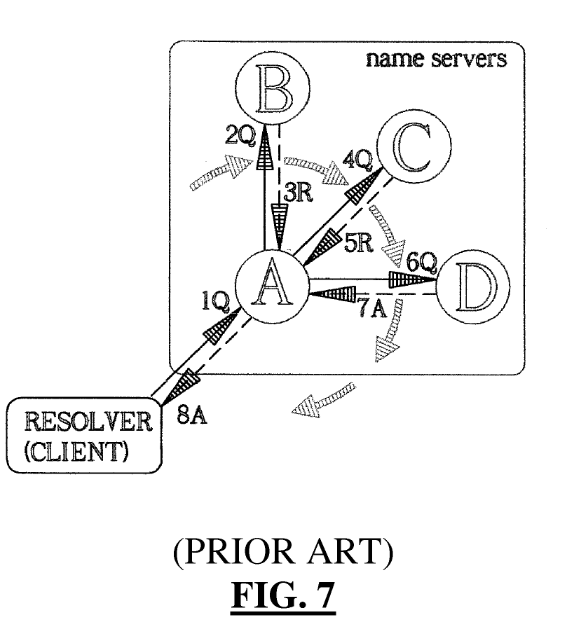

FIG. 7 original book caption was “FIG. 2-13. The resolution process”.

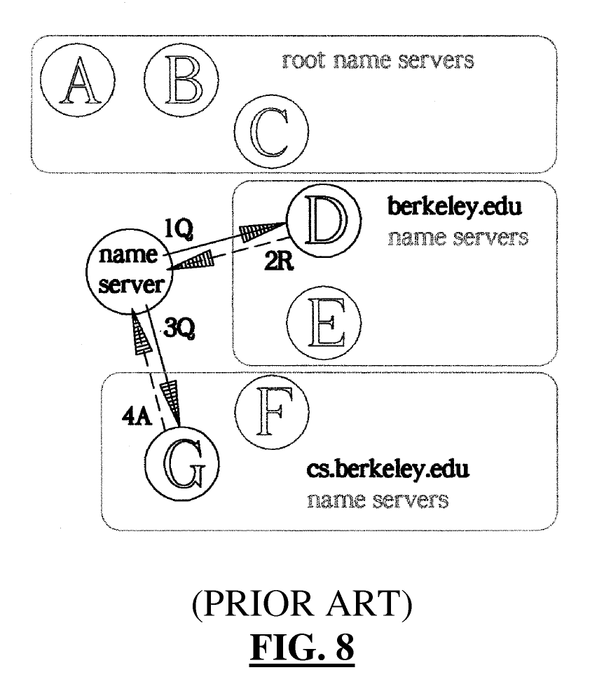

FIG. 8 original book caption was “FIG. 2-16. Resolving baobab.cs.berkeley.edu”.

I have listed here below, the text abbreviations related to the respective corrected figures:

### GENERAL LEGEND

Q stands for Query
R stands for Referral
A stands for Answer

In FIG. 6:
1Q stands for “resolver query”
2Q stands for “query for address of “girigiri.gbrmpa.gov.au””
3R stands for “referral to “au” name servers”
4Q stands for “query for address of “girigiri.gbrmpa.gov.au””
5R stands for “referral to “gov.au” name servers”
6Q stands for “query for address of “girigiri.gbrmpa.gov.au””
7R stands for “referral to “gbrmpa.gov.au” name servers”
8Q stands for “query for address of “girigiri.gbrmpa.gov.au””
9A stands for “address of “girigiri.gbrmpa.gov.au””
10A stands for “answer”

FIG. 7 had a “list” of the steps and the following abbreviations in [xx]:

1—[1Q] Name server A receives a query from the resolver.

2—[2Q] A queries B.

3—[3R] B refers A to other name servers, including C.

4—[4Q] A queries C.

5—[5R] C refers A to other name servers, including D.

6—[6Q] A queries D.

7—[7A] D answers.

8—[8A] A returns answer to resolver.

FIG. 8 had a “list” of the steps and the following abbreviations in [xx]:

1—[1Q] query for “baobab.cs.berkeley.edu”'s address

2—[2R] referral to F & G

3—[3Q] query for “baobab.cs.berkeley.edu”'s address

4—[4Q] address of “baobab.cs.berkeley.edu”

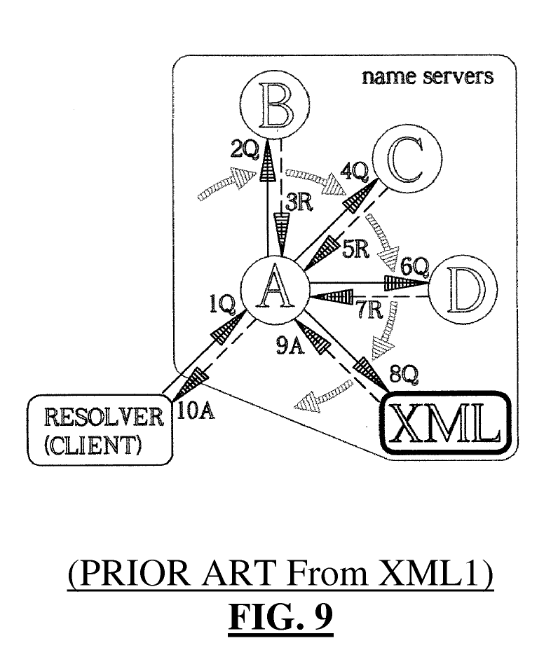

FIG. 9 had a “list” of the steps and the following abbreviations in [xx]:

1—[1Q] Name server A receives a query from the resolver.

2—[2Q] A queries B.

3—[3R] B refers A to other name servers, including C.

4—[4Q] A queries C.

5—[5R] C refers A to other name servers, including D.

6—[6Q] A queries D.

7—[7R] D refers to A to XML.

8—[8Q] A queries XML.

9—[9Q] XML answers.

10—[10A] A returns answer to Resolver.

### DETAILED DESCRIPTION OF THE INVENTION

As mentioned earlier in the summary, there are several inventions here. I will describe them as we go along. I will however group them into individual groups. The specifications will cover all these groups of inventions.

Benefits of the Proposed Invention to the Internet Email World:

The proposed service will salvage stray email messages on the Internet, will preserve the interconnectability between Senders and Recipients, and will generally facilitate the “mobility” of Internet Email users.

Users need to change their email addresses from time to time. They may relocate to another town that is not serviced by their old Internet Service Provider (ISP), or they may not be satisfied with one ISP and may like to utilize the services of another. Or they may simply like to control the amount of SPAM, that comes to them and obtain a new email address, which would not be known to the old SPAM senders. By subscribing to our “XMAIL™” service, Recipient users become assured that their “selected” email correspondence to any of their old addresses will continue uninterrupted. Same service can be provided to groups of subscribers and/or to ISPs as well.

Logistics:

We, or any authorized provider of the proposed service, would make it known to the Internet users' world, that this service is available to them. Any particular user would be able to partake or subscribe to the service, for a fee. They may opt to use the service for a few weeks, a few months or for any time duration that they feel would be necessary for their particular transition situation.

We would also make the service known to the Internet Service Providers (ISPs). Our service will be of special interest to any ISP, who is promoting and trying to expand his business. The ISP can offer to provide our forwarding service at no charge to their prospective customers, explaining that there will be no interruption in their mail flow even if they switch from an old ISP.

Mechanics: See FIGS. Xx ss xxx. Ref#s.

The way to make all this happen is a simple “IF . . . . Then . . . ” statement that can be added into the “SENDMAIL” program. IF the program encounters a case of “undeliverable” message, THEN the program's IF statement would tell the system to (1) forward the message to the “XMAIL™” server. The XMAIL™ server would lookup/“query” the old/invalid address in the database files, find the new valid address and (2) provide it to the system, by giving the “answer” in reply to the query. The system would “rewrite” the name of the recipient and deliver the message. This would satisfy the first objective of this invention.

An optional additional feature would be to notify the sender of the whole story. This can happen before sending the message to the recipient, thus giving the sender the option to verify the new address before sending the message. Or this can happen after redirecting and sending the message, simply to inform the sender of what happened and giving him/her the new address for future use. This would satisfy the second objective of this invention.

Another option would be to add a notification to the delivered message, alerting the recipient that a “redirection” has taken place, so that the recipient could take whatever appropriate action he/she may feel necessary. This would satisfy another one of the objectives of this invention.

Of course if the old address and its corresponding new address are not in the database files, then XMAIL™ will notify the system of this fact and the system would go back to the “Mailer-Daemon” and proceed as in the past.

One of the most desirable options is to subscribe directly to XMAIL™ and use it as the principal ISP for the user.

Security:

A lot of safeguards would be in place to prevent unauthorized misuse of, or tampering with, the system. For example, the user would have to check and recheck the correctness of his old and new addresses. The XMAIL™ system will also check a number of “identifiers” to ascertain the authenticity and legitimacy of the inputs and ensure that no “malicious” entries are accepted into the database files.

### DESCRIPTION OF THE PREFERRED EMBODIMENTS

While the invention is susceptible of various modifications and alternative constructions, certain illustrative embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as described in the Specification and as defined in the claims.

While I am describing the drawing in more details, I will at the same time explain the technology basis of the invention. I will also include a number of examples in this section, which should be considered as part of the embodiments for the purpose of this application as well.

This description covers more than one invention. The inventions are based partly on the same technology platform, but then each of the inventions has some additional features of its own. Not being an expert in handling patents, I would like to leave it to the patent examiner to decide on the number of the inventions contained and how to split one invention from the other.

When referring to the preferred embodiments, certain terminology will be utilized for the sake of clarity. Use of such terminology is intended to encompass not only the described embodiment, but also technical equivalents which operate and function in substantially the same way to bring about the same result.

It should of course be understood that the description and drawings herein are merely illustrative and that various modifications and changed can be made in the methods and systems disclosed without departing from the spirit of the invention.

Many of the steps, methods and procedures mentioned herein are based on normal ones already established and being used in the present Internet world. The selective use of these steps, methods, procedures and systems is what makes the invention what it is. Any individual well versed in the art and field being addressed would know how what needs to be done to implement them, based on the descriptions and explanations given in this specification.

I will use the following example to illustrate how the present old system operates and how the proposed improved system will operate. I will use the case of the user Mr. Albert Einstein. A partially similar example was given in one of the reference books listed above.

Let us say that Mr. Albert Einstein was at UC Berkeley and his email address was “aeinstein@berkeley.edu”. Let's say that Mr. Einstein moves to Boston to join MIT. He changes his email address to “aeinstein@mit.edu”.

Now, we can visualize two scenarios: First, what would happen if we still have the present system, as is. Second, what would happen if we adopt XMAIL™, according to this invention?

1. Present Old System:

Let's say that a third party user, Mr. Pablo Picasso, Sender, sends an email message to Mr. Einstein, Recipient, at his old address “aeinstein@berkeley.edu”. According to the way the present system is configured now, when the message reaches the host computer at UC Berkeley, the message would be rejected, because such a name is no more an active name in its database files. After a few such attempts, the system will return the message to the Sender, Mr. Picasso, informing him that the message is “undeliverable”, because the address is “invalid”.

Please refer back to my explanations above, about the RESOLUTION PROCESS, and to FIGS. 6 through 8.

I will explain the process again, using FIG. 7.

The Client/Resolver would represent Mr. Picasso. Mr. Picasso's host computer would query A, which would query B, C, and D, where D would represent UC Berkeley, and would ultimately receive an answer from D saying that this aeinstein@berkeley.edu is invalid.

Notice the list of the steps that happen in FIG. 7 (the list was shown on page 15 above). the list summarizes the 8 steps used in this Resolution process.

2. With the XMAIL™ system:

On the other hand, once the XMAIL™ system is adopted and installed and is running on the Internet, in the market, there will be better choices. See FIG. 9. Please see also the list of the steps that occur in FIG. 9. These steps are shown in page 16 of the present application.

a) Mr. Einstein could subscribe to our service, as an individual subscriber, and would notify XMAIL™ about his change of address. Then, both the old address and its corresponding new address will be stored in the XMAIL™ database files. XMAIL™ will contact the person at (the owner of) the old address and verify the validity and acceptance of the address change. XMAIL™ could repeat this validation/acceptance check a number of times, at different times, to ensure that the change is for real, before it officially accepts the change and before putting it on the system mainstream.

b) The other way to record the address change with XMAIL™ is that if the authorities at MIT, or the new ISP, or any third party, would do that for Mr. Einstein. MIT could inform XMAIL™ of the change of address of Mr. Einstein. However, in such a case, XMAIL™ will verify directly with Mr. Einstein himself, again more than once, to make sure that the address change is really what Mr. Einstein wants. Only then, will XMAIL™ store the information in its database files and place it in the mainstream of its operation.

So now, once the change of address is entered in the XMAIL™ system, XMAIL™ will start to do its job. If after all that has happened, Mr. Picasso, Sender, sends an email message to Mr. Einstein at his old address “aeinstein@berkeley.edu”, the message will follow the normal route and will arrive at UC Berkeley and will be rejected, the same way as would have happened with the old system. This is represented in FIG. 9 by the path “Client/Resolver-A-B-A-C-A-D-A-Resolver/Client”, exactly as shown also in FIG. 7.

However, here is the improvement.

This is illustrated in FIG. 9. Please see also the list of the steps that occur in FIG. 9. These steps are shown in page 16 of the present application.

Please compare FIG. 9 with FIG. 7. Please see also the list of the steps that occur in FIG. 7. These steps are shown in page 15 of the present application.

You will notice that the XML has been inserted in FIG. 9 to show that XML is in the system now.

So now, when D, which would be “ucberkely.edu”, determines that “aeinstein@berkeley.edu” is not a valid address, instead of informing A that the address is not valid, D would refer A to XML, step 7R in FIG. 9. Now A will query XML, step 8Q in FIG. 9, asking XML to find aeinstein. XML will search in its database files, finds aeinstein's new/present valid address and will send an answer to A, step 9A in FIG. 9, telling A that XML has aeinstein.

So, the difference between FIG. 7 and FIG. 9 is the “two additional steps”, steps 7 and 8 in FIG. 9, where the system interrogates the newly introduced XML node to get a valid address.

Now, A returns his answer, step 10A in FIG. 9, to the Client/Resolver, which then proceeds to send the message to aeinstein.

aeinstein could be at XML or he could be at @mit.edu or at any other ISP.

To recap.

Because of the added feature provided by XMAIL™ (in SENDMAIL or the like), the system now will generate one additional query. This time, the query will go to XMAIL™, to the XMAIL™ host computer, and will “query” XMAIL™ for an answer relating to this “old” address. XMAIL™ will search/look-up in its data stored in its database files and will extract the “new” address of Mr. Einstein, which is “aeinstein@mit.edu” and inform the system, by giving an “answer” to the system of the new address. This is represented in FIG. 9 by the path “Client/Resolver-A-B-A-C-A-D-A-XML-A-Resolver/Client”. The system will re-route the message to the new address and deliver it to Mr. Einstein, at “aeinstein@mit.edu”.

### Logistics

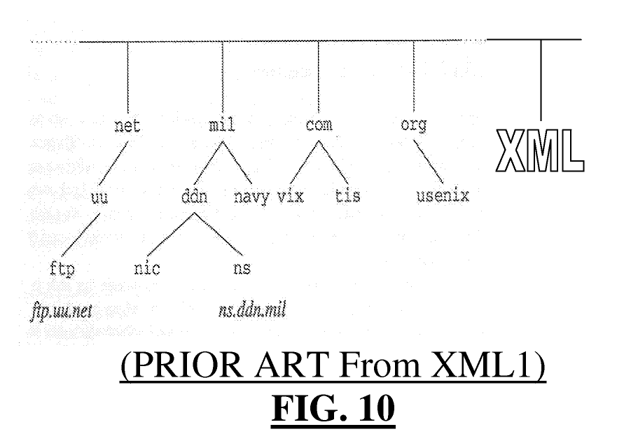

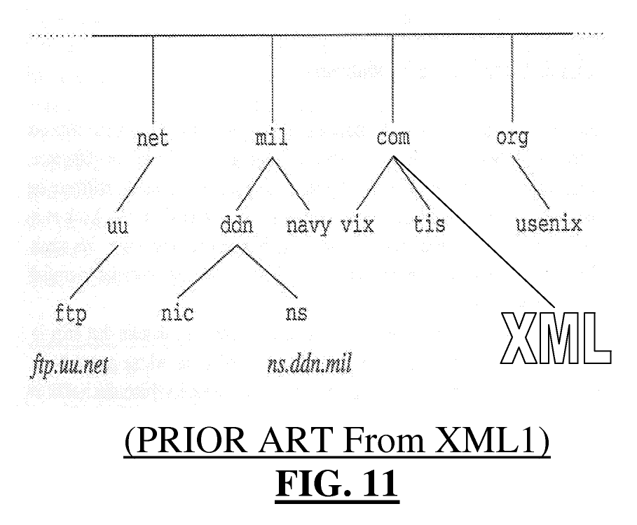

Please see FIGS. 10 and 11.

In order for the above procedure to happen, XML should somehow be hooked up to the Internet already.

One way is shown in FIG. 10. XML could be established as a top level node, directly under the root node of the Internet. So, it will be an “.XML”.

Another way is shown in FIG. 11. In this case, XML could be established as a second level node, say under “.com”. So, it will be called “XML.com”.

Either way, XML per se would be accessible to other name servers and will be able to provide the service explained here.

In addition, if Mr. Einstein had selected this option, then the system will inform Mr. Einstein that the re-routing that took place, giving Mr. Einstein the opportunity to inform Mr. Picasso of the address change.

Additional Features:

Regarding notifications, Mr. Einstein would have several options:

1. Mr. Einstein may opt that the system does not inform him about the “re-routing”.

2. Mr. Einstein may instruct the system, to keep his new address confidential, and not to divulge it to any Sender.

3. Mr. Einstein may instruct the system, to keep his new address selectively confidential, and to divulge it only to certain Senders, which Mr. Einstein would list in advance.

4. Mr. Einstein may instruct the system, to keep his new address selectively confidential, and to divulge it to the Sender of a particular message, after viewing the message.

5. Mr. Einstein may instruct the system to inform him about the “re-routing” and to decide what to do in each individual case. For example, he may decide that Mr. Picasso should be notified and be informed about Mr. Einstein's new address, but he may decide that other sender should not be notified of the new address.

In other words, the notification of either the Recipient and/or the Sender would be a selective choice process. A number of variations can be visualized.

Regarding discarding messages, the system may be instructed to selectively discard messages from certain Senders, such as SPAM senders. Here again, there could be a number of variations. The system may discard those SPAM messages without showing them to Mr. Einstein based on his previous instructions, or the system could place those SPAM messages in a special group and identify them as SPAM and would let Mr. Einstein view them first and then delete them at his will. In a way, this would be pretty similar to various methods used by Anti-Spam software, such as Norton Symantec, in handling SPAM.

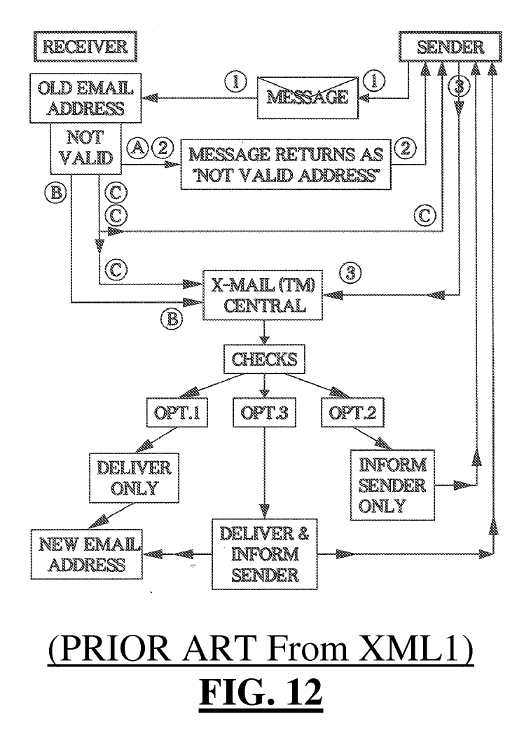

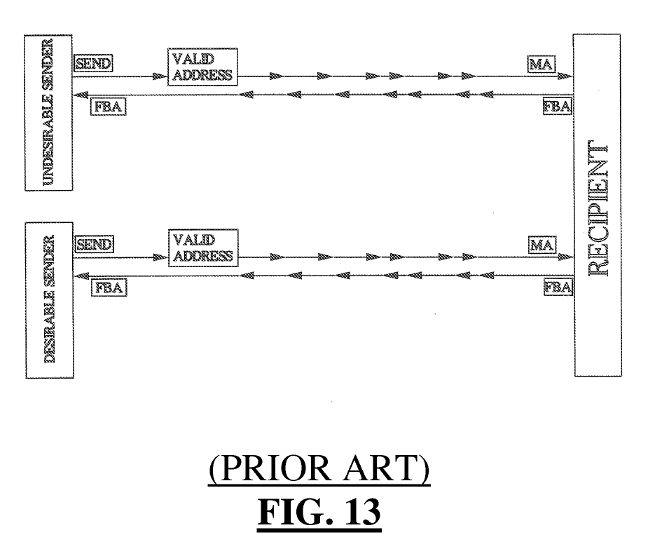

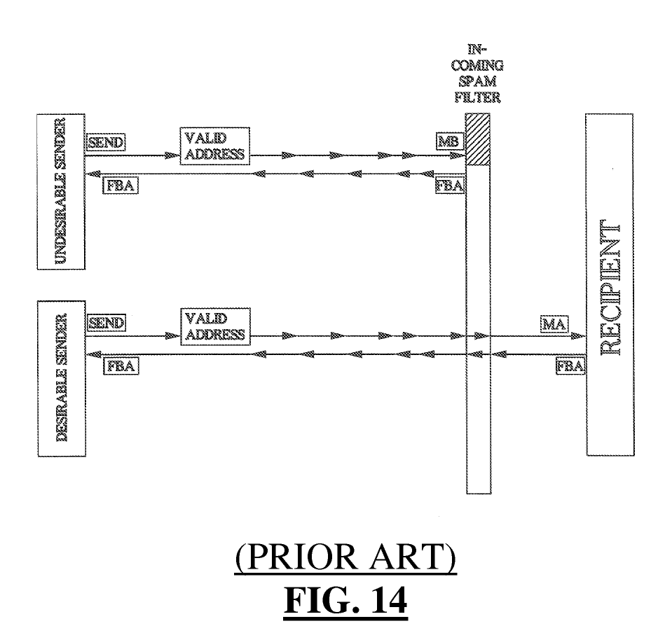

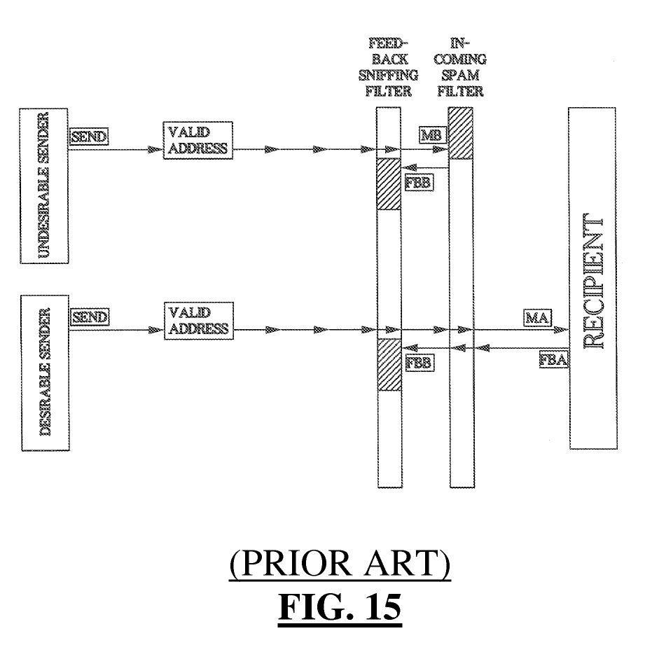

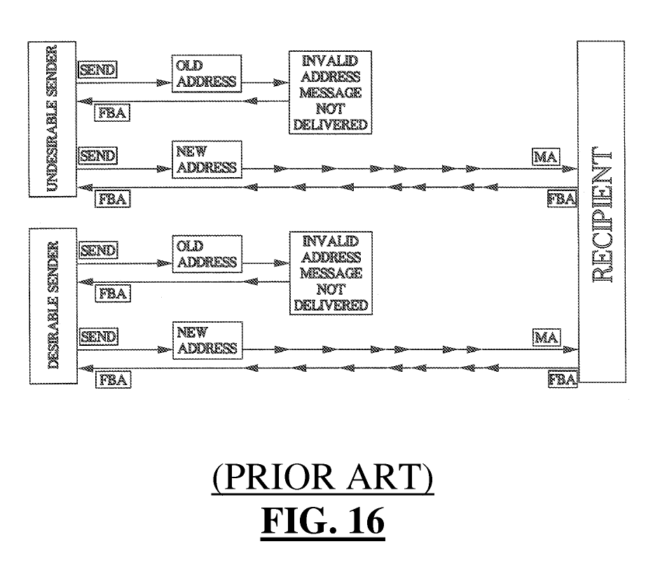

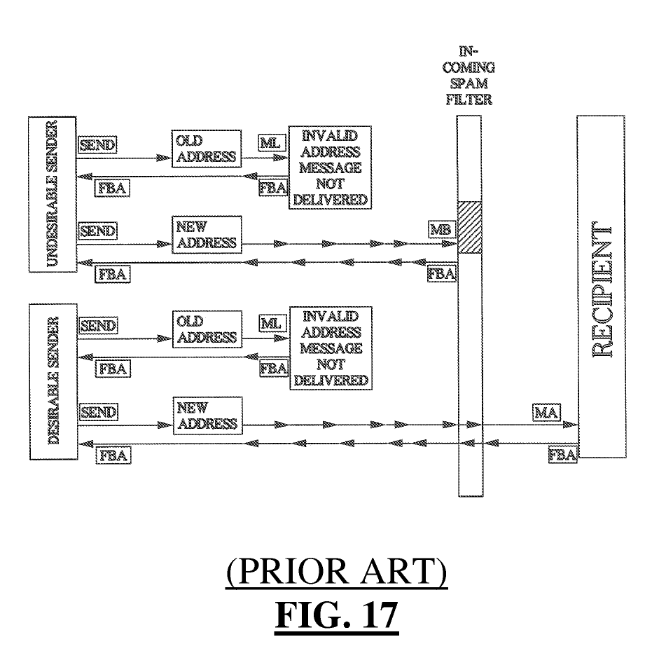

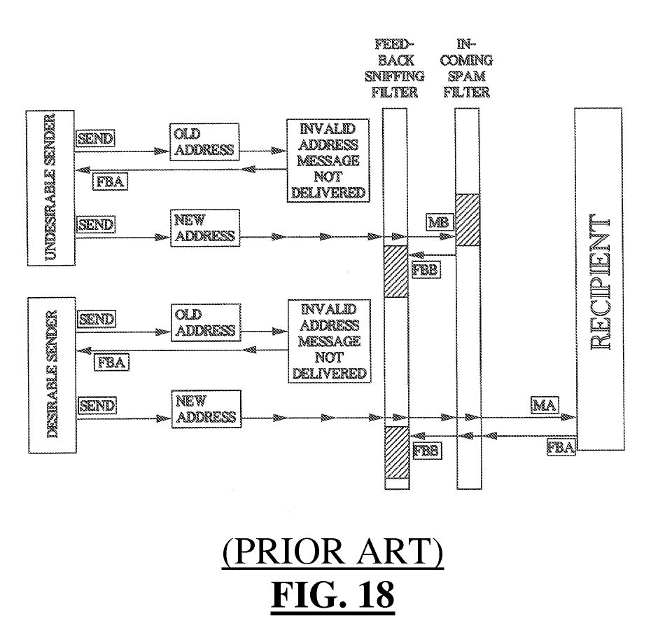

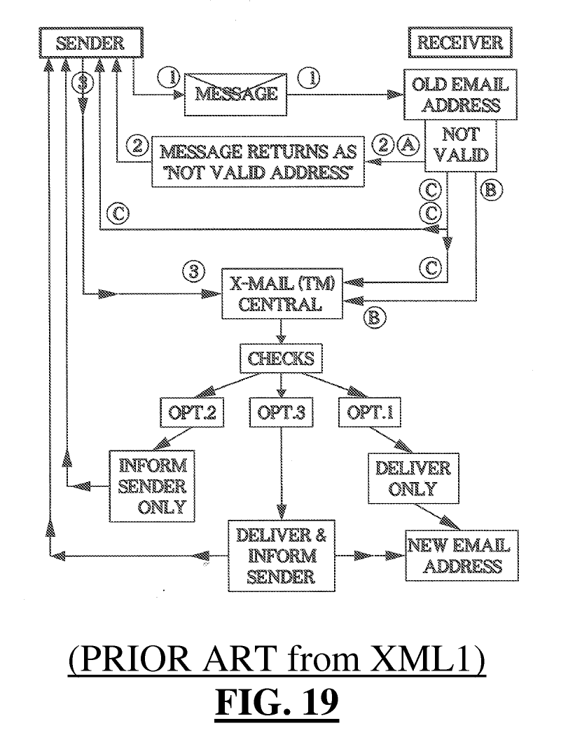

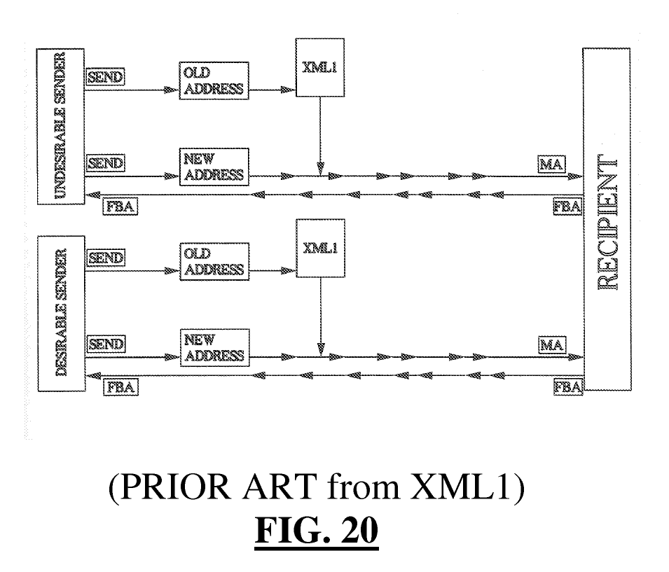

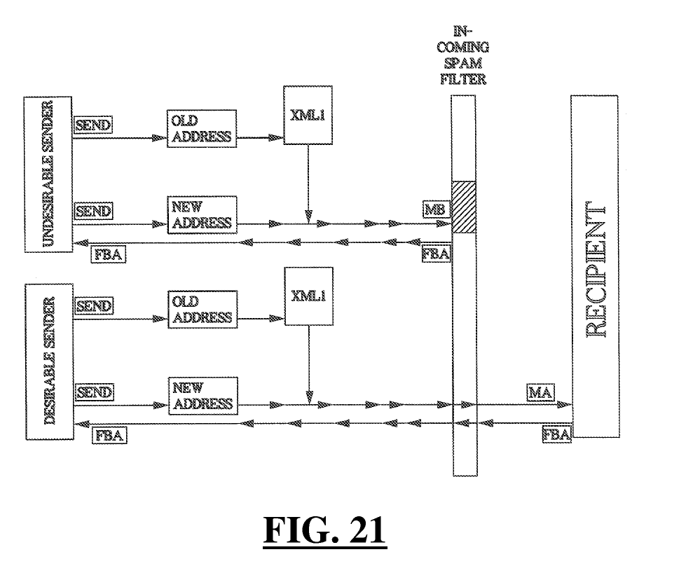

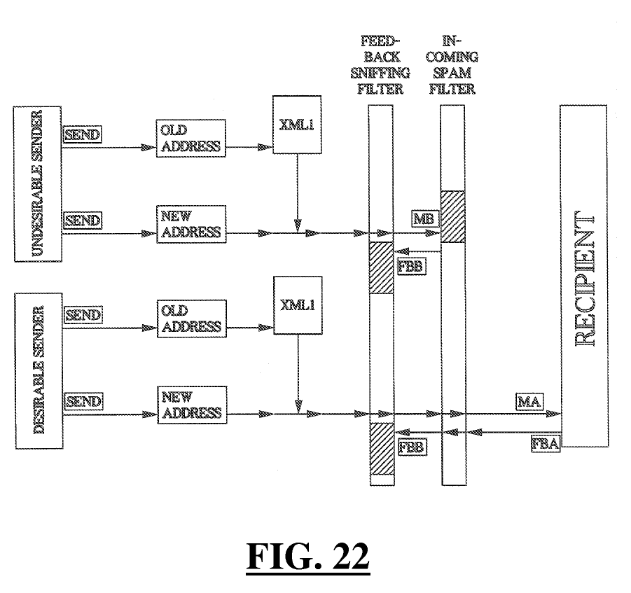

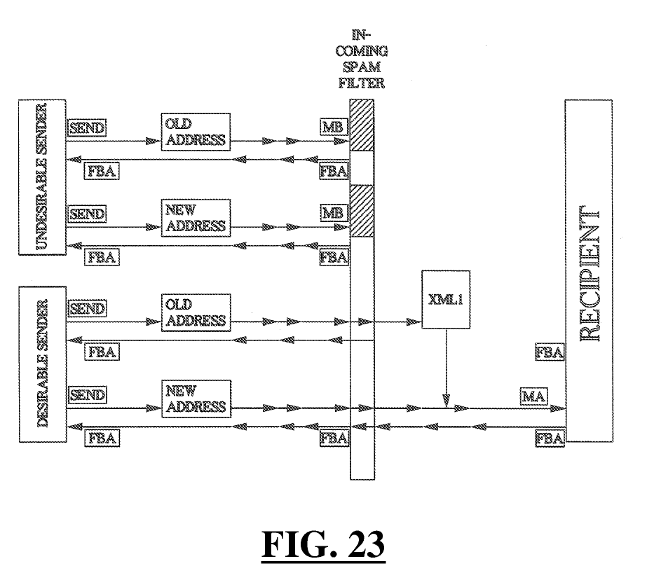

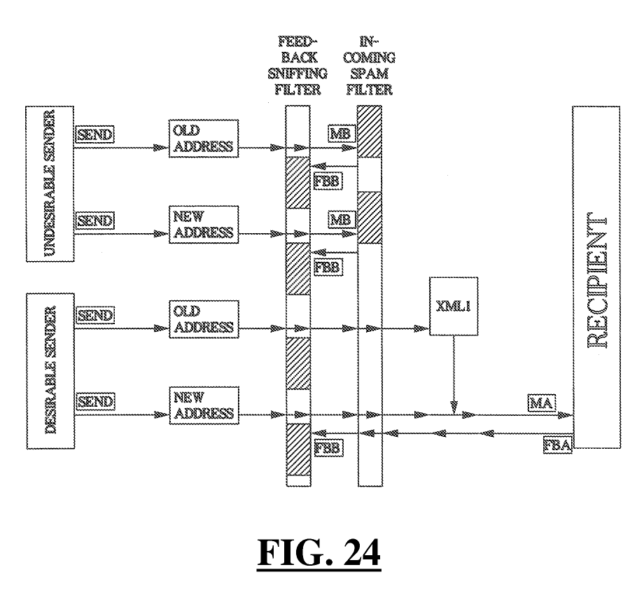

FIG. 12 shows a rough flow chart for some of the process steps described above.

Step 1. The sender uses an old email address of his recipient.

Now there are at least three possible outcomes. Either Step 2 and 2A, or Step 2B, or Step 2C, depending on whether XML is in existence and on the options selected previously with XML.

Step 2 and 2A. The Host Computer of the old address of the recipient returns the message as undeliverable because the address is invalid.

Step 2B. When XML Central is existing and operating, then Host Computer of the old address of the recipient would send the message to XML, or sends a query to XML to find out whether the sender has a new valid address.

Step 2C. When XML Central is existing and operating, then Host Computer of the old address of the recipient would send the message to XML, or sends a query to XML to find out whether the sender has a new valid address.

If Step 2B or Step 2C were selected, then XML would check its database files. If the sender is in the database files, then XML would proceed with one or more of the following steps, again depending on the options selected previously by the participating sender.

Option 1. XML would answer the recipient's Host Computer and would give him the recipient's new valid address and the message will be transferred appropriately to the recipient. XML does not inform the sender of this transaction.

Option 2. XML does not answer the recipient's Host Computer and does not give him the recipient's new valid address. So the message will not be transferred to the recipient. However, XML will inform the sender of the recipient's new address, provided that the recipient had instructed XML to do so.

Option 3. XML does both what is in Options 1 and 2. In other words, XML will answer the recipient's Host Computer and will give him the recipient's new valid address. So the message will be transferred to the recipient. In addition, XML will inform the sender of the recipient's new address, provided that the recipient had instructed XML to do so.

Other options are available, but are not shown in this FIG. 12. Some have been already described earlier. They include the following:

Option 4. XML does not answer the recipient's Host Computer and does not give him the recipient's new valid address. So the message will not be transferred to the recipient. However, XML may keep the message and will inform the recipient that a message was sent by the sender. XML would keep the message, waiting for the recipient to decide what to do with it.

Option 4a. The recipient can decide to view the message first and then either keep it or discard it.

Option 4b. The recipient can decide to view only the name of the sender of the message first and then decide to either view it or not, before deciding to either keep it or discard it.

Option 4c. The recipient can instruct XML to discard those messages right away, without even viewing the message.

Option 4d. The recipient can instruct XML to discard only those messages that came from a certain sender or group of senders, which the recipient had determined previously and informed XML about them. In other words, those senders would be on the “blocked” list.

Many other options are conceivable, regarding the interaction between XML and the participating receiver.

Also several options are conceivable, regarding the interaction between XML and other participating users, if they are the sender themselves.

Furthermore, other options are conceivable regarding the interaction between XML and other Users and Hosts on the Internet.

### Example Options

1. All mail goes directly to XML. In this case, XML would act as the main central HUB.
2. Some Hosts would sing-up with XML and their message traffic would automatically receive the proper support from XML, especially in case of stray messages.
3. Users can sign-up with XML as their main or sole ISP, using a name such as aeinstein@XML.com, for example.
4. Users can sign-up with XML as their secondary/support ISP, using a name such as aeinstein@mit.edu/xml.com, or aeinstein@mit.edu/xml, for example.
5. and so on.

Potential Difficulties:

1—Objections from Old ISP:

In the above example, where Mr. Einstein moves from Berkeley to MIT, there may not be any animosity in the move and Berkeley would cooperate in the proposed scheme of things. However, if the move is from one ISP to another, say from AOL to CompuServe or vice versa, then the old ISP may not be happy about losing the customer to the new ISP. In such a case, the old ISP may try to place roadblocks to undermine the system from operating as intended.

To overcome such potential difficulties, users/customers should request a contractual agreement/promise from their ISP, preferably before signing-up with those ISP, stating that if the customer ever decides to switch, at any time in the future, to another ISP, that their old ISP would cooperate in the transaction of re-routing and forwarding procedure, as per present invention. Possibly, there could be a law enacted to make such behavior automatic and expected.

2—Duplication of Names:

Even if Berkeley decides to cooperate and does not give Mr. Einstein any hard time for moving to MIT, there may be another problem in the way of the system to function properly. Suppose that Mr. Einstein's cousin or distant relative, by a name of Augustus Einstein, decides to join Berkeley. He gets an Internet/Email address at Berkeley and decides to make his email address “aeinstein@berkeley.edu”.

Although the full names of Albert Einstein and Augustus Einstein are obviously different, their “abbreviated” email addresses are identical.

So, if a message is sent to Albert at Berkeley, the Berkeley host computer will automatically deliver the message to Augustus. Of course, Augustus will most probably forward the message to Albert, but this can become a nuisance if it keeps happening repeatedly and too often. Worse things can happen, too. Say, after a while, Augustus gets so annoyed that he does not forward the messages anymore to Albert, and simply deletes them. Then Albert will be cut off from his “lawful” email correspondence.

This example simply illustrates what could happen, if Berkeley allows the use of an “old” email address/name to be used by a new user, other than the first user who selected that address/name in the first place.

So, to prevent such mishaps, it would be advisable and recommended that once a “user-name” or “email address/name” is selected at any “host” location, that other users should never use the same name at any other time afterwards, at least at that same “host” location. An easy way to accomplish this is to add some identifier to names that look alike. For example, if Mr. Albert Einstein was the first user to adopt the name “aeinstein@berkeley.edu”, then any other users with similar user-name, in this case Mr. of Augustus Einstein would have to select a user-name like “aeinstein2@berkeley.edu”, or “aeinsteinb@berkeley.edu”, or any other user-name which will be different that the one used originally by Mr. Albert Einstein.

This kind of agreement can be something that the Internet Users World could agree to voluntarily, or it may be enacted by law, if the voluntary approach does not get accepted. In essence, this would be similar to the Agreement about the ISP names to avoid duplicities. There could be a similar agreement about individual users names as well.

XMAIL™ will follow such a rule as far as its subscribers are concerned. If Mr. Albert Einstein would be an existing subscriber, with his old email addresses being “aeinstein@berkeley.edu”, and then later on, Mr. Augustus Einstein tries to subscribe to XM with a similar email address as “aeinstein@berkeley.edu”, then XM will have to create a way to differentiate between them, or at least between the messages coming in with this address. This can be done internally, by identifying the two names as #1 and #2 say, and using some inputs and identifying data, from both Mr. Albert and Mr. Augustus and some creative coding from the part of XM. Such identifiers could include the dates of usage of the names,

A world wide “universal” code name could be created, by XML or any other organization, giving every living person or group, an unrepeated identifying number or code, like the telephone numbers, even with the area code and the country code. There would be a huge number of people, but it is still a concrete number. The numbers will still be manageable, if we use a digital format, and include letters, number, etc.

A compromise could be made, say that there should be a moratorium of a number of years, before such a name can be reused. Personally, I do not like such a compromise. Another proposed method/embodiment is for any and all ISPs to ask XML first, before accepting any request for a new email address, so as to ensure that this new requested email address does not exist in the system already. In other words, XML would become the Repository for ALL email addresses. In a way, it will be doing a similar job for email addresses as ICANN is doing for ISPs. This would ultimately lead to a situation, where XML would be the “center” for issuing all email addresses. This would also lead to what I would call the “Universal Email address for Life” or the “Universal XML Code” or “UXMLC” or simply “XMLC”. We could settle for the term “Universal ID” or “UID”.

Universal User's Name or Universal ID Code

Several schemes can be visualized for such Universal User's Names or Universal ID Codes. I would like to propose some here below.

1. Combine the user's old email name/address with the XML.com ending. For example, if we start with “aeinstein@berkeley.edu”, then the new name would become aeinstein @berkeley.edu.xml.com

1. Combine the user's old email name/address with some add-ons “identifier” to make it unique. For example, use his birth date as the identifier. If we start with “aeinstein@berkeley.edu”, it would become aeinsteinyyyymmdd@berkeley.edu. Not knowing the exact birth date of Mr. Einstein, let's just assume that his birth date is Oct. 21, 1931 say. So his email address would be aeinstein19311021@berkeley.edu.

3. Combine the user's old email name/address with his birth date, but use the numerical value of the date like for the Julian calendar for example. Pursuing the above example, this would then be aeinstein11617@berkeley.edu

4. Combine the user's old email name/address with his birth date and a consecutive number to be assigned by the system, if we expect to have a lot of users by the same name and born on the same birth date. In this case, it could end up being like aeinsteinyyyymmdd###@berkeley.edu. Pursuing the above example, this would then be aeinstein19311021999@berkeley.edu or aeinstein11617@berkeley.edu.

Etc.

These identifiers could be used internally within the XML system or within any similar system. In other words, the visible name in the address does not need to be extremely long. At one time, an ISP was using alphanumeric name for the users. Almost like the telephone numbers. It could be a good idea to revive that method.

### Now, for the Continuation in Part to the Above

This is the NEW part, which is the core of the present application, that I am adding to the Mother Application, which was excerpted above.

### NEW OR REPEATED LEGEND & ABBREVIATIONS & DEFINITIONS

### A ALLOWED

### B BLOCKED

FB FEED BACK MESSAGE to Sender, re Recipient receiving original msg.

### FBA Feed Back Message Allowed

### FBB FEED BACK MESSAGE BLOCKED

### MA MESSAGE ALLOWED or Message Arrived

### Mb Message Blocked

### ML MESSAGE LOST

### R RECIPIENT

### RECIPIENT RECIPIENT

### S SENDER

### SENDER SENDER

### XML Exchange System for Email Messages

XML1 XML1, as covered by Mother Application, Ref1
XML2 XML2, as covered by this present patent application.

### FIELD OF THE INVENTION

The present invention relates to the way email messages are handled on the Internet. It relates particularly to handling stray email messages, like messages sent to a wrong or old/invalid email address, and how to salvage such messages and optionally to get them to their proper destinations and/or destined recipients. It also relates particularly to methods used to fight “spam” and to fight “phishing” or “sniffing”.

### OBJECTIVE OF THE INVENTION

The objective of the present invention is to add a few more concepts, methods and improvements in the way email messages are handled on the Internet. It builds on what has been covered in the Mother Application, XML1/Ref2, and then incorporates some other “Prior Art” methods together with XML1, to end up with a more powerful and more beneficial and sometimes more economical end results, especially for the recipients of the emails messages.

The Prior Art methods referred to here are two-folds: First, the method of removing spam and any such undesirable messages coming from undesirable senders, by using spam filters. I will refer to this as the “Anti-Spam Filter” or the “In-Coming Spam Filter”. Second, the method of fighting and reducing the process known as “phishing” or “sniffing”. I will refer to this as the “Feed-Back Sniffing filter”.

Both these two methods have been used by many service providers in the industry and are well known to the experts in the field and to their respective recipients customers.

The novelty here is to combine these prior art methods together with the novel methods described in the Mother Application, XML1, also referred to as Ref1.

To recap the methods of XML1, they relate generally to email messages, which are handled on the Internet. More particularly, they relate to “stray” email messages [Definition] that are sent out by “senders”, where the sender has used an “old” email address of the recipient, and/or where the email address of the “recipient” is considered “not valid” any more. Like in the case of where the Recipient had changed his/her email address, and the Sender is not aware of the change. Then the email message cannot be delivered to its destined recipient.

The invention also relates to the problem of having the messages returned to the sender as “undeliverable”, and/or loosing these stray messages in the system, which results in possibly loosing the connection between the sender and the recipient.

The invention further relates to and proposes ways to correct the situation and to avoid such a loss and to provide means, systems and methods, which can help in salvaging such stray messages and “optionally” in re-connecting the users on the Internet.

The invention can also be extended and applied to other fields or activities, where items are handled back and forth, such as parcels and packages, which are handled by the US Postal Service, FEDEX, UPS and the like.

Again in different words, the objective of XML1 is to salvage stray email messages, whenever a message is sent to an old invalid email address and to redirect such messages to their correct recipients. And depending on the options selected by the participants in the system, the new/valid email address of the recipient can be communicated to the sender. Other options can be selected as well.

Another objective is to provide the above services on a continuous basis, not for a period of 6 months or so, like some ISP do when they force their clients to change their email addresses, and it would not be cut-off at the whims of the ISP, but at the pleasure of the participating users. In other words, this would be a stand-alone commercial business providing the services described here.

The proposed methods, services, systems, etc. would lead to the establishment of “Universal Email Addresses” or “Universal IDs” for the participating users.

In addition to the remarks in XML1, I would like to add that another objective is to apply the methods and systems described here, to other communications schemes. For example, the same inventions and similar schemes can be applied to Telephones and Telephone Numbers, whether Land telephones or Cell phones, to Faxes, to Regular (snail) mails, and the like.

### BRIEF DESCRIPTION OF THE INVENTION

The purpose of the XML1 invention is to overcome the difficulties encountered when a person changes his/her email address, whether purposely or forced by layoffs or by changing of employment or residence or otherwise.

We have all heard the terrible news these days about the millions of workers who have been laid-off by their employers, either because the employers are cutting back or because the employers have gone totally out of business. When such a worker, say John Doe, looses his job, he also looses his email address. Usually the employer gives the employee an email access, which usually would be something like “john.doe@xyz.com”, for example for this John Doe working at ZYZ Company. Also most of the contact of John Doe and their addresses are kept on the company's computer. When John is laid off, he usually looses track of all his contacts, whether business contacts or even personal contacts. After being laid off, John would most probably create a new email address via a new Internet Service Provider. John now will be faced with trying to re-establish his contacts, and re-construct his email address list, but this is a horrendous task, if not impossible. John will most probably loose a lot of his previous contacts. The purpose and goal of the present invention is to help John recover most of his previous contacts, by redirecting any email message coming from any of those old contacts to the new email address of John, even if the old contacts have sent their email messages to John's old invalid email address. This has been and still is the goal of XML1.

However, with the amount of email traffic that is floating around and the heavy electronic marketing efforts going on nowadays, John may become overwhelmed with that traffic. Due save John some time, it would be helpful to John, if the superfluous “spam” email traffic could be eliminated from his incoming emails. This is the purpose of the present Continuation In Part application. By using the anti-spam filters, we can reduce the spam traffic heading towards John. Also, by using the anti-sniffing filters, we can reduce the chance of John's getting on future spam lists.

So again, in brief, the invention's main objective is to create an automatic method of redirecting the so-called “undeliverable” or “stray” email messages to the new address. A second objective is to alert the recipient user that a “redirection” has occurred. A third objective is to notify the sender(s) about the new address for future use, either automatically or optionally, if the recipient wishes that this be done.

The inventions described in this present application combine the two prior art methods for fighting “spam” and “sniffing or phishing” together with the XML1 invention, to improve the traffic of email messages on the Internet.

The method of accomplishing these objectives is described here below.

### PRIOR ART

Spam cleaning methods are well known in the industry and I will consider them as one group of the prior art methods that I will use in this invention.

Also methods of fighting “sniffing” and/or “phishing” are another group of methods that are known in the industry and I will use them here as well. They are the second group of prior art methods that I will use in this invention.

The third group of methods that I will use in this invention is the group of methods that I had described in my XML1/Ref1 Mother Application. I have not heard from the US Patent Office yet whether any of those methods are in the prior art. As far as I know, I have not found any such methods or approached in the prior art.

### BRIEF DESCRIPTION OF THE DRAWINGS

FIGS. 1 through 12 were described above as part of XML1.

FIGS. 13 through 24 are the new drawings as per present Continuation In Part application.

FIGS. 13 through 15 show the flow of email messages between senders and recipients, when the senders use valid email address. FIG. 13 shows the case where there is no intervention, while FIG. 14 shows the effect of an anti-spam filter and FIG. 15 shows the effect of adding also a feedback sniffing filter.

FIGS. 16 through 18 again show the flow of email messages between senders and recipients, as in FIGS. 13 through 15, but here the senders have used both an old/invalid email address in some cases and a new/valid address in other cases; and they show the effect of interventions from anti-spam filter and feedback sniffing filters.

FIG. 19 shows a summary of the XML1 methods, described in my Mother Application, XML1 or Ref1. This drawing is the mirror image of FIG. 7.

FIGS. 20 through 22 show the same things that were in FIGS. 16 through 18, but after introducing the XML1 feature in the flow of the messages. Here the XML1 feature is placed “ahead” or “in front” of the anti-spam filter and of the feedback sniffing filter.

FIGS. 23 and 24 are similar to FIGS. 21 and 22 respectively, except that the XML1 features were place “behind” the other filters.

### DETAILED DESCRIPTION OF THE INVENTION AND PREFERRED EMBODIMENTS

FIGS. 1 through 12 are duplicates of the figures used in my Mother Application, XML1. FIGS. 1 through 8 show the situation with the existing Prior Art. Then FIGS. 9 through 12 show the situation with XML1 intervention, which has been described in my Mother Application, XML1. This is why I have identified these FIGS. 9 through 12 as “PRIOR ART from XML1”.

FIGS. 13 through 18 show the situation with the existing Prior Art. Then FIGS. 19 and 20 show the situation with XML1 intervention, which has been described in my Mother Application, XML1. So again, I have identified these figures as “PRIOR ART from XML1”. Then finally FIGS. 21 through 24 show the improved situations as per present invention.

FIG. 13 shows the flow of email messages between “senders” and “recipients”. Senders can be considered “desirable” or “undesirable”, where the undesirable ones are those who send spam messages or the like. The upper half of the figure shows the activities of undesirable senders, and the lower half the activities of desirable senders. In either case, the senders in this case have used a “valid” email address and the message arrives “MA” to the recipient. Certain senders request to get a “feed back” message, indicating whether the message has arrived to the recipient. Some senders use this technique to establish whether the email address that they have used is a valid address or not. This is to cull out any invalid addresses. They use this technique to collect good, valid addresses, to be used in future marketing efforts. This is called “sniffing” or “phishing”. Usually, the feed back is allowed “FBA” automatically. The recipient usually cannot stop it from happening.

FIG. 14 shows the same thing as in FIG. 13, except that here we see that there is a filter placed in the way of the incoming messages. This is an “incoming spam filter”. Here, the filter monitors the incoming messages and checks whether any of the messages contains “undesirable” contents, which can be specified in advance by the recipient or by some other ways. If the filter detects an undesirable message or undesirable content, it interrupts the message and prevents it from reaching the recipient, as shown in the upper half of the figure. If the filter does not detect any undesirable content, then the message passes through and arrives at the recipient, as in the lower half of the figure. In both cases, the “feed back message” is allowed (FBA) to go back to the sender. Such a filter is called a spam filter, as the name implies.

FIG. 15 shows the same thing as in FIG. 14, but with one additional filter, namely the “feed back sniffing filter”. Again, as the name implies, this filter prevents any feed back messages from going back to the sender, as shown both in the upper half of the figure as well as in the lower half. This is to fight sniffing or phishing.

The rest of the figures show the case where the recipient has changed his/her email address. Some senders may still send messages to the old address while other senders will use the new address. Again, the upper half of the figure shows the activities of undesirable senders, and the lower half the activities of desirable senders. Also, both the upper and the low halves are each divided into two portions. The upper portion show the messages sent to “old address”, and the lower portion the messages sent to the “new address”.

FIG. 16 shows the case, where the senders have sent one message to the old address and another message sent to the new address. Also, in this figure we notice that there is no intervention from any of the filters mentioned above. The messages sent to the new addresses will arrive to the recipients, and the feed back messages will be returned to the senders. However, the messages sent to the old addresses will not arrive to the recipients. They will get lost in the Internet world, and a message is usually returned to the sender, notifying the sender that the address he/she has used was invalid and the message cannot be delivered.

FIG. 17 shows the same thing as in FIG. 16, except that the Incoming Spam Filter now is intervening and doing what it was doing in FIGS. 14 and 15.

FIG. 18 shows the same thing as in FIG. 17, except that here the Feed Back Sniffing Filter is also intervening and doing what it was doing in FIG. 15.

FIG. 19 shows the “mirror image” picture of FIG. 12. I had noticed that many people, including Mr. Dale Williams, prefer to show the flow from left to right. So, I am trying to comply with the acceptable norm.

FIG. 20 shows the summary effect of using the methods described in XML1. The senders have sent out messages using both the old address and the new address, as in FIG. 16. However, here the XML1 will intervene, and will redirect the messages that were sent to the old addresses, so that they will somehow arrive to the recipient. The details as to how this redirection or salvaging happens is explained in full details in the Mother Application, XML1/Ref1, as I have repeated most of it here above.

All the above figures are considered Prior Art, either generic Prior Art or “Prior Art from XML1”. The following figures show the novel concepts as per the present invention.

### Preferred Embodiments

The following four figures show four of the PREFERRED EMBODIMENTS as per present invention. Then two more PREFERRED EMBODIMENTS will be described, without using any figures, because it will be obvious as the way they will be composed and put together.

### Preferred Embodiment #1

FIG. 21 shows one of the novel features of this invention, and which I will call PREFERRED EMBODIMENT #1. Here I have combined my XML1 methods together with an “incoming spam filter”. The filter will catch the messages from the undesirable sender, or the undesirable messages, and prevent them from reaching the recipient. This will happen, regardless of whether the address used was an old address or a new address. This is because the XML1 methods will re-direct all the messages with the old address, regardless of whether they are desirable or not, so that it will be conveyed to the recipient's new address or new destination anyway. The lower half of the figure show a similar redirection of the message with the old address, and both messages of the lower half of the figure will arrive to the recipient because the spam filter did not detect any undesirable contents and allowed them to pass through. However in all these cases, the feed back messages did go back to the senders.

### Preferred Embodiment #2

FIG. 22 shows the same thing as in FIG. 21, but with the addition of the feedback sniffing filter. I will call this PREFERRED EMBODIMENT #2. Again as in FIGS. 15 and 18, this filter prevents the feedback messages from returning to the senders.

### Preferred Embodiment #3

FIG. 23 shows an improvement on what was shown in FIG. 21. I will call this PREFERRED EMBODIMENT #3. Here the XML1 intervention is placed “after” the spam filter, or in other words the spam filter is placed ahead of or in front of the XML1. The effect is to have less volume of messages go through the XML1. Let me explain. In FIG. 21, all the undesirable messages that were sent using the old address will go through XML1, then they will get redirected and then go to the spam filter. But in FIG. 23, none of these messages will go to XML1 because the filter would have caught them ahead of time. So, in spite of the fact that the anti-spam filter will do the same amount of work or effort in both cases, yet the XML1 filter will do only half the work, or at least a smaller percentage of the work done in the case of FIG. 21, depending on the percentage of spam with respect to the total email traffic. This saves equipment time, energy and wear and tear, and improves the total efficiency of the total system.

### Preferred Embodiment #4

FIG. 24 shows a similar improvement on what was shown in FIG. 22. I will call this PREFERRED EMBODIMENT #4. Here again, the XML1 intervention is placed “after” both the spam filter and the sniffing filter, or in other words the spam filter and the sniffing filter are placed ahead of or in front of the XML1. The effect is practically the same as the one of FIG. 23. Both the anti-spam filter as well as the feedback sniffing filter will be doing the same amount of work and effort in both case of FIG. 24 as in FIG. 22. However, the XML1 intervention will do much less work in FIG. 24 than in the case of FIG. 22.

### Preferred Embodiment #5

I am not showing a figure for this embodiment. In this embodiment, we will put a spam filter in front of the XML1 as well as after it. The first spam filter, in front of the XML1, would catch any general ordinary spam that is generally undesirable to the Internet traffic. The second spam filter, placed after or behind the XML1, will catch specific spam messages that were especially specified by, and directed to, the recipient.

### Preferred Embodiment #6

Again, I am not showing a figure for this embodiment. In this embodiment, we will put more than one filter in front of the XML1, and again more than one filter after or behind the XML1. The filters could include anti-spam filters, anti-sniffing filters and the like. Again, the filters in front or ahead the XML1 will be more general filters, i.e. to catch any objectionable messages for all and any recipient, while the filters behind the XML1 would be more targeted to the specific desires of the particular recipient.

In all the above, the software programs and the methods used for the anti-spam filter as well as for the feedback sniffing filter, are well know in the industry, and I do not think it is necessary to describe them in this application.

Also, the methods used for the XML1 feature are described in Ref1 application, and I have reprinted most of the specification describing them here above.

1. A system, for salvaging stray email messages on the Internet and for reducing the traffic of undesirable email messages on the Internet, comprising
a) a host computer, referred to hereafter as the XMAIL™ Server or simply XMAIL™, to act as a repository center, to store information correlating old “invalid” email addresses, and possibly other contact data, of participating users, hereinafter referred to as the recipients, to their corresponding new “valid” email addresses, in database files, referred to herein after as Master Exchange Database or simply XMAIL™ Database,
b) a software program and established procedures, which control the handling of the information and the messages on the Internet, referred to hereafter as the Internet Control Program, and
c) at least one software program capable of reducing the frequency of undesirable events on the Internet, said program referred to as a filter,
wherein
d) when an email message sent to a recipient through the Internet system is determined to be addressed to an old invalid address,
e) a query is sent to the Xmail™ Server to obtain the corresponding new valid address,
f) and the Internet Control Program will then use this information to redirect the message in question to its intended recipient at that new valid address, and then after that
g) said filter will monitor the email messages and if it detects any undesirable features in the message, the filter will then prevent said message from going to the recipient.

2. A system, like in claim 1, wherein
said filter software is an “anti-spam” filter.

3. A system, like in claim 1, wherein
said filter software is an “anti-sniffing” filter, or “anti-phishing” filter.

4. A system, like in claim 1, wherein
at least two filter software programs are used instead of only one, either of these two programs being capable of reducing the frequency of undesirable events on the Internet, and
wherein
one of said two programs is an “anti-spam” filter and the second of said two software programs is an “anti-sniffing” or “anti-phishing” filter.

5. A system, like in claim 1, wherein
said XMAIL™ Server and XMAIL™ Database are incorporated into said Internet Control Program.

6. A system, for reducing the traffic of undesirable email messages on the Internet and for salvaging stray email messages, comprising
a) at least one software program capable of reducing the frequency of undesirable events on the Internet, said program referred to as a filter,
b) a host computer, referred to hereafter as the XMAIL™ Server or simply XMAIL™, to act as a repository center, to store information correlating old “invalid” email addresses, and possibly other contact data, of participating users, hereinafter referred to as the recipients, to their corresponding new “valid” email addresses, in database files, referred to herein after as Master Exchange Database or simply XMAIL™ Database, and
c) a software program and established procedures, which control the handling of the information and the messages on the Internet, referred to hereafter as the Internet Control Program,
wherein
d) said filter will monitor the email messages sent through the Internet system and if it detects any undesirable features in a message, the filter will prevent said undesirable message from continuing their path, and would allow only the acceptable messages to pass through to the next step in the system, and then after that,
e) the Internet Control Program will monitor only these acceptable messages, and whenever it detects that an email message was sent to that recipient, addressed to an old invalid address, then
f) a query is sent to the Xmail™ Server to obtain the corresponding new valid address,
g) and the Internet Control Program will then use this information to redirect the message in question to its intended recipient at that new valid address.

7. A system, like in claim 6, wherein
said filter software is an “anti-spam” filter.

8. A system, like in claim 6, wherein
said filter software is an “anti-sniffing” filter, or “anti-phishing” filter.

9. A system, like in claim 6, wherein
at least two filter software programs are used instead of only one, either of these two programs being capable of reducing the frequency of undesirable events on the Internet, and
wherein
one of said two programs is an “anti-spam” filter and the second of said two software programs is an “anti-sniffing” or “anti-phishing” filter.

10. A system, like in claim 6, wherein
said XMAIL™ Server and XMAIL™ Database are incorporated into said Internet Control Program.

11. A system, for reducing the traffic of undesirable email messages on the Internet and for salvaging stray email messages, comprising
a) at least one first software program capable of reducing the frequency of undesirable events on the Internet, said program referred to as a first filter,
b) a host computer, referred to hereafter as the XMAIL™ Server or simply XMAIL™, to act as a repository center, to store information correlating old “invalid” email addresses, and possibly other contact data, of participating users, hereinafter referred to as the recipients, to their corresponding new “valid” email addresses, in database files, referred to herein after as Master Exchange Database or simply XMAIL™ Database,
c) a software program and established procedures, which control the handling of the information and the messages on the Internet, referred to hereafter as the Internet Control Program, and
d) at least one second software program capable of reducing the frequency of undesirable events on the Internet, said program referred to as a second filter,
wherein
e) said first filter will monitor the email messages sent through the Internet system and if it detects any undesirable features in a message, the filter will prevent said undesirable message from continuing their path, and would allow only the acceptable messages to pass through to the next step in the system, and then after that,
f) the Internet Control Program will monitor only these acceptable messages, and whenever it detects that an email message was sent to that recipient, addressed to an old invalid address, then
g) a query is sent to the Xmail™ Server to obtain the corresponding new valid address,
h) and the Internet Control Program will then use this information to redirect the message in question to its intended recipient at that new valid address, and then after that,
i) said second filter will monitor the email messages sent to the recipient through the Internet system and if it detects any undesirable features in a message, the filter will then prevent said message from going to the recipient.

12. A system, like in claim 11, wherein
each of said first filter software and said second filter software is an “anti-spam” filter.

13. A system, like in claim 11, wherein
each of said first filter software and said second filter software is an “anti-sniffing” filter, or “anti-phishing” filter.

14. A system, like in claim 11, wherein
each of said first filter software and said second filter software comprises one or more programs out of the following group of programs: an “anti-spam” filter, an “anti-sniffing”, an “anti-phishing” filter or any similar programs that are intended to reduce undesirable email messages from circulating on the Internet.

15. A system, like in claim 11, wherein
said XMAIL™ Server and XMAIL™ Database are incorporated into said Internet Control Program.
